(19) United States
(12) Patent Application Publication
(10) Pub. No.: US 2025/0190266 A1
(43) Pub. Date: Jun. 12, 2025

(54) RESERVING COMPUTING RESOURCES IN CLOUD COMPUTING ENVIRONMENTS

(71) Applicant: SAP SE, Walldorf (DE)

(72) Inventors: Hui Li, Shanghai (CN); Haijing Lin, Shanghai (CN)

(21) Appl. No.: 18/534,877

(22) Filed: Dec. 11, 2023

(51) Int. Cl. G06F 9/50

(52) U.S. Cl. CPC G06F 9/505

(57) ABSTRACT

Methods, systems, and computer-readable storage media for dividing a set of services into a set of service groups, the set of nodes being provisioned in a container orchestration system in a cloud computing environment, determining, for a service group, a similarity matrix including a set of similarity scores, each similarity score representative of a similarity between a service in the service group and a node in the set of nodes in terms of resources required by the service and available resources of the node, generating, for the service group, a bipartite graph including, for each service, a set of edges, each edge connecting the service to a node and having an edge weight, providing a set of service-node pairs for the service group based on edge weights, and, for each service in the service group, deploying the service to a node for execution in the cloud computing environment.

### BACKGROUND

Cloud computing can be described as Internet-based computing that provides shared computer processing resources, and data to computers and other devices on demand. A common architecture in cloud platforms includes services (also referred to as microservices), which have gained popularity in service-oriented architectures (SOAs). In such SOAs, applications are composed of multiple, independent services that are deployed in standalone containers with well-defined interfaces. The services are deployed and managed within the cloud platform and run on top of a cloud infrastructure. For example, an application that is deployed to a cloud platform can be composed of a set of services that are executed within the cloud platform. Each service is itself an application (e.g., a Java application) and one or more instances of a service can execute within the cloud platform.

In modern software deployments, containerization is implemented, which can be described as operating system (OS) virtualization. In containerization, services are run in isolated user spaces referred to as containers. The containers use the same shared OS, and each provides a fully packaged and portable computing environment. That is, each container includes everything an application needs to execute (e.g., binaries, libraries, configuration files, dependencies). Because a container is abstracted away from the OS, containerized applications can execute on various types of infrastructures. For example, using containers, an application can execute in any of multiple cloud-computing environments.

Container orchestration automates the deployment, management, scaling, and networking of containers. For example, container orchestration systems, in hand with underlying containers, enable applications to be executed across different environments (e.g., cloud computing environments) without needing to redesign the application for each environment. Enterprises that need to deploy and manage a significant number of containers (e.g., hundreds or thousands of containers) leverage container orchestration systems. An example container orchestration system is the Kubernetes platform, maintained by the Cloud Native Computing Foundation, which can be described as an open-source container orchestration system for automating computer application deployment, scaling, and management. The container orchestration system can scale a number of containers, and thus resources to execute services that make up one or more applications.

### SUMMARY

Implementations of the present disclosure are directed to deploying services for execution in cloud computing environments. More particularly, implementations of the present disclosure are directed to distributing services for execution by nodes of a cloud computing environment by matching resource requirements of services with resources of nodes.

In some implementations, actions include dividing a set of services that are to be deployed to nodes in a set of nodes into a set of service groups, the set of nodes being provisioned in a container orchestration system in a cloud computing environment, determining, for a first service group in the set of service groups, a similarity matrix including a set of similarity scores, each similarity score representative of a similarity between a service in the first service group and a node in the set of nodes in terms of resources required by the service and available resources of the node, generating, for the first service group in the set of service groups, a first bipartite graph including, for each service in the first service group, a set of edges, each edge connecting the service to a node in the set of nodes and having an edge weight, providing a first set of service-node pairs for the first service group based on edge weights of the first bipartite graph, and, for each service in the first service group, deploying the service to a node in a respective service-node pair for execution in the cloud computing environment. Other implementations of this aspect include corresponding systems, apparatus, and computer programs, configured to perform the actions of the methods, encoded on computer storage devices.

These and other implementations can each optionally include one or more of the following features: the first set of service-node pairs is determined by executing maximum matching over the first bipartite graph based on the edge weights; available resources include processing, memory, and network bandwidth; actions further include executing load testing of nodes in the set of nodes, to which the services in the first service group are deployed, and updating available resources of the nodes in the set of nodes based on the load testing; actions further include providing a second set of service-node pairs for a second service group based on edge weights of a second bipartite graph, and for each service in the second service group, deploying the service to a node in a respective service-node pair for execution in the cloud computing environment; the second service group includes at least one placeholder service; the edge weights of the second bipartite graph are determined at least partially based on updated available resources of the nodes in the set of nodes after deployment of nodes in the first service group to the nodes in the set of nodes; actions further include receiving a request for the service, and transmitting the request to the node for execution by the service; a number of services in the set of services is evenly divisible by a number of nodes in the set of nodes, such that each service group in the set of service groups has the same number of services therein; a number of services in the set of services is not evenly divisible by a number of nodes in the set of nodes, such that one service group in the set of service groups has fewer services therein than other service groups in the set of service groups; and actions further include providing an adjacency matrix including a matrix of edge weights, each edge weight corresponding to a service-node pair and representing a similarity between a service and a node in the service-node pair relative to similarities of all other service-node pairs in the bipartite graph.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example container orchestration architecture.

FIG. 3 depicts a representation of a bipartite graph in accordance with implementations of the present disclosure.

FIGS. 4A and 4B depict example processes that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to deploying services for execution in cloud computing environments. More particularly, implementations of the present disclosure are directed to distributing services for execution by nodes of a cloud computing environment by matching resource requirements of services with resources of nodes. Implementations can include actions of dividing a set of services that are to be deployed to nodes in a set of nodes into a set of service groups, the set of nodes being provisioned in a container orchestration system in a cloud computing environment, determining, for a service group in the set of service groups, a similarity matrix including a set of similarity scores, each similarity score representative of a similarity between a service in the service group and a node in the set of nodes in terms of resources required by the service and available resources of the node, generating, for the service group in the set of service groups, a bipartite graph including, for each service in the service group, a set of edges, each edge connecting the service to a node in the set of nodes and having an edge weight, providing a set of service-node pairs for the service group based on edge weights of the bipartite graph, and, for each service in the service group, deploying the service to a node in a respective service-node pair for execution in the cloud computing environment.

To provide further context for implementations of the present disclosure, and as introduced above, cloud computing can be described as Internet-based computing that provides shared computer processing resources, and data to computers and other devices on demand. A common architecture in cloud platforms includes services (also referred to as microservices), which have gained popularity in service-oriented architectures (SOAs). In such SOAs, applications are composed of multiple, independent services that are deployed in standalone containers with well-defined interfaces. The services are deployed and managed within the cloud platform and run on top of a cloud infrastructure. For example, an application that is deployed to a cloud platform can be composed of a set of services that are executed within the cloud platform. Each service is itself an application (e.g., a Java application) and one or more instances of a service can execute within the cloud platform.

In modern software deployments, containerization is implemented, which can be described as operating system (OS) virtualization. In containerization, services are run in isolated user spaces referred to as containers. The containers use the same shared OS, and each provides a fully packaged and portable computing environment. That is, each container includes everything an application needs to execute (e.g., binaries, libraries, configuration files, dependencies). Because a container is abstracted away from the OS, containerized applications can execute on various types of infrastructure. For example, using containers, an application can execute in any of multiple cloud-computing environments.

Container orchestration automates the deployment, management, scaling, and networking of containers. For example, container orchestration systems, in hand with underlying containers, enable applications to be executed across different environments (e.g., cloud computing environments) without needing to redesign the application for each environment. Enterprises that need to deploy and manage a significant number of containers (e.g., hundreds or thousands of containers) leverage container orchestration systems. An example container orchestration system is the Kubernetes platform, maintained by the Cloud Native Computing Foundation, which can be described as an open-source container orchestration system for automating computer application deployment, scaling, and management.

Container orchestration systems, such as the Kubernetes platform, include many nodes that can be provided as virtual machines (VMs), for example. Containers are deployed in the nodes and are used to execute services. Typically, different services have different resource requirements in terms of hardware resources and/or software resources consumed to execute the service. For example, some services can require high-performance resources (e.g., CPUs, memory, disk, and/or network bandwidth), some services need only low- or mid-performance resources (e.g., CPUs, memory, disk, and/or network bandwidth), and some services can require multiple types of resources.

The resources that can be allocated by the different nodes are also different. The total resources that can be provided by all nodes may be less than the sum of the maximum required resources of all of the services, as usually all of the services do not reach their peak resource consumption at the same time. However, provisioning the maximum required resources over all of the services is inefficient in that it results in largely idle, hence wasted resources.

In view of the above context, implementations of the present disclosure are directed to a service deployment framework for distributing services for execution by nodes of a cloud computing environment by matching resource requirements of services within a service group with resources of available nodes. As described in further detail herein, the service deployment framework of the present disclosure improves resource consumption of nodes in cloud computing environments.

Implementations of the present disclosure are described in further detail herein with non-limiting reference to an example container orchestration system, namely, Kubernetes. It is contemplated, however, that implementations of the present disclosure can be realized using any appropriate container orchestration system.

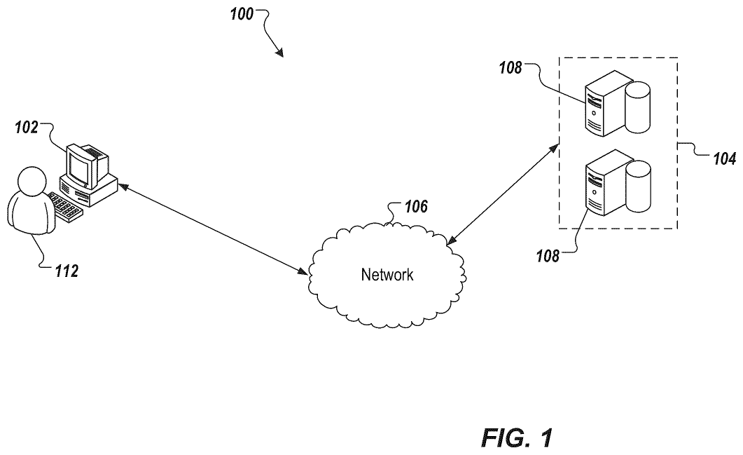

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

The server system 104 can provide a cloud computing environment that includes a container orchestration system for provisioning nodes within the cloud computing environment. In accordance with implementations of the present disclosure, the server system 104 can provide a service deployment framework for deploying services in the cloud computing environment. In some examples, the service deployment framework is provisioned within the container orchestration system.

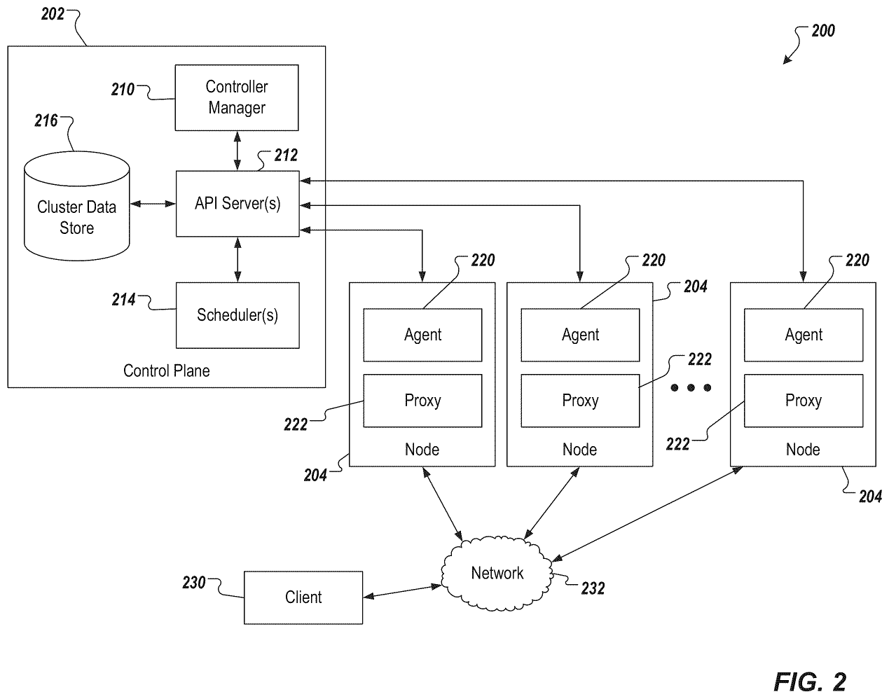

FIG. 2 depicts an example container orchestration architecture 200. In the depicted example, the example container orchestration architecture 200 represents deployment of a portion of the container orchestration system Kubernetes introduced above. More particularly, the example architecture 200 represents a basic structure of a cluster within Kubernetes.

In the example of FIG. 2, the example architecture 200 includes a control plane 202 and a plurality of nodes 204. Each node 204 can represent physical worker machines and are configured to host pods. In Kubernetes, a pod is the smallest deployable unit of resources and each pod is provided as one or more containers with shared storage/network resources, and a specification for how to run the containers. In some examples, a pod can be referred to as a resource unit that includes an application container. The control plane 202 communicates with the cluster of nodes 204 and is configured to manage all of the nodes 204 and the pods therein. It should be noted that additional control planes and associated clusters of nodes may form a part of the cloud environment, but are not shown in FIG. 2 for clarity.

In further detail, the control plane 202 is configured to execute global decisions regarding the cluster as well as detecting and responding to cluster events. In the example of FIG. 2, the control plane 202 includes a control manager 210, one or more application programming interface (API) server(s) 212, one or more scheduler(s) 214, and a cluster data store 216. The API server(s) 212 communicate with the nodes 204 and exposes the API of Kubernetes to exchange information between the nodes 204 and the components in the control plane 202 (e.g., the cluster data store 216). In some examples, the control plane 202 is set with more than one API server(s) 212 to balance the traffic of information exchanged between the nodes 204 and the control plane 202. The scheduler(s) 214 monitor the nodes 204 and execute scheduling processes to the nodes 204. For example, the scheduler(s) 214 monitors events related to newly created pods and selects one of the nodes 204 for execution, if the newly created pods are not assigned to any of the nodes 204 in the cluster.

The cluster data store 216 is configured to operate as the central database of the cluster. In this example, resources of the cluster and/or definition of the resources (e.g., the required state and the actual state of the resources) can be stored in the cluster data store 216. The controller manager 210 of the control plane 202 communicates with the nodes 204 through the API server(s) 212 and is configured to execute controller processes. The controller processes can include a collection of controllers within control manager 210 and each controller is responsible for managing at least some or all of the nodes 204 within the cluster. The management can include, but is not limited to, noticing and responding to nodes when an event occurs, and monitoring the resources of each node (and the containers in each node). In some examples, the controller in the controller manager 210 monitors resources stored in the cluster data store 216 based on definitions of the resource. As introduced above, the controllers also verify whether the actual state of each resource matches the required state. The controller is able to modify or adjust the resources to mitigate under- and over-provisioning of resources.

In some examples, the controllers in the controller manager 210 should be logically independent of each other and be executed separately. In some examples, the controller processes are all compiled into one single binary that is executed in a single process to reduce system complexity. It is noted the control plane 202 can be run/executed on any machine in the cluster. In some examples, the control plane 202 is run on a single physical worker machine that does not host any pods in the cluster.

In the example of FIG. 2, each node 204 includes an agent 220 and a proxy 222. The agent 220 is configured to ensure that the containers are appropriately executing within the pod of each node 204. The agent 220 is referred to as a kubelet in Kubernetes. The proxy 222 of each node 204 is a network proxy that maintains network rules on nodes 204. The network rules enable network communication to the pods in the nodes 204 from network sessions inside or outside of the cluster. The proxy 222 is a kube-proxy in Kubernetes.

In some examples, each node 204 can be described as a compute instance that provides computing resources (e.g., processors, memory, network bandwidth) for executing one or more services. In some examples, the compute instance is provided as a virtual machine (VM) executed on hardware. More particularly, and as described in further detail herein, each node 204 executes one or more instances of services that are deployed to respective nodes 204 in accordance with implementations of the present disclosure. Deployment of a service can includes transmitting a computer-executable file of the service (e.g., binary file) to a node 204 and executing the computer-executable file at the node to enable the service to receive requests, process the requests, and output responses. In some examples, a client 230 can submit requests for handling by one or more services over a network 232 (e.g., the Internet). For example, the client 230 can submit a request through an API and the request can be routed to a service, which is executed on a node 204, for handling. The service can generate a response to the request, which is routed back to the client 230. Although a single client 230 is depicted in FIG. 2, it is contemplated that any appropriate number of clients can submit requests to services.

In accordance with implementations of the present disclosure, a service deployment framework is provisioned within a container orchestration architecture (e.g., container orchestration architecture 200 of FIG. 2). For example, the service deployment framework can be provisioned within a control plane (e.g., the control plane 202). In some examples, the service deployment framework can be used to deploy M services to N nodes. In many cases, M is greater than N, frequently significantly larger than N.

In some implementations, the M services are evenly divisible by N nodes. As a non-limiting example, suppose there are 45 total services (M=45) and 3 nodes in the cluster (N=3). In this non-limiting example, the M services are evenly divided into K server groups (K=M/N=15) where each of the server groups includes P services (M/K=P=3). In this example, N=P for all service groups.

In some implementations, the M services are also divided into K service groups, but the M services are not evenly divisible by N nodes. As such, the service group count K is:

$$K = ⌈ \frac{M}{N} ⌉$$

where the operator ┌ ┐ indicates a ceiling (e.g., rounding up). In some cases, the number of services in one of the service groups can be less than P (e.g., in instances where M is not evenly divisible by N). For purposes of non-limiting illustration, M services can be equal to 27 and N nodes can be equal to 4. As such, K can be equal to 7 service groups (27/4=6.75, which is rounded-up to 7, such that K=7. In this non-limiting example, to substantially evenly distribute the 27 services across the 7 service groups, 6 of the service groups (K−1) will have 4 services assigned thereto

$$( P = \frac{M}{K - 1} = 4 ) ,$$

and 1 of the service groups will have the remaining 3 services assigned thereto (remaining services (R)=M−P(K−1)). Thus, in this non-limiting example, for all of service groups but one, N=P and for the 1 service group N>R).

Services of the M services can be assigned to service groups using any appropriate technique. In some examples, services are randomly assigned to service groups. Other example techniques can include, without limitation round-robing and round-robin with priority.

A similarity matrix is determined between services of a service group and the nodes within the cluster. Continuing with the above example, a similarity matrix is determined between 4 (or 3) of the individual services within each of the 7 service groups and the 4 nodes in the cluster. To achieve this, a vector rsᵢ representing the resources required by the i^{th} service can be defined as:

rsᵢ=[cpuReqᵢ,memReqᵢ,netReqᵢ,diskReqᵢ]

where cpuReqᵢ is the maximum normalized CPU usage required by the i^{th} service, memReqᵢ is the maximum normalized memory usage required by the i^{th} service, netReqᵢ is the maximum normalized network bandwidth usage required by the i^{th} service, and diskReqᵢ is the maximum normalized disk usage required by the i^{th} service. In some examples, cpuReqᵢ, memReqᵢ, netReqᵢ, diskReqᵢ are determined from historical executions of the i^{th} service. In some examples, 0≤cpuReqᵢ<1, 0≤memReqᵢ<1, 0≤netReqᵢ<1, and 0≤diskReqᵢ<1.

In some examples, a vector rnⱼ representing the resources that can be currently provided by the j^{th} node can be defined as:

rnⱼ=[cpuProⱼ,memProⱼ,netProⱼ,diskProⱼ]

where cpuProⱼ is the normalized CPU usage provided currently by the j^{th} node, memProⱼ is the normalized memory usage provided currently by the j^{th} node, netProⱼ is the normalized network bandwidth usage provided currently by the j^{th} node, and diskProⱼ is the normalized disk usage provided currently by the j^{th} node. In some examples, cpuProⱼ, memProⱼ, netProⱼ, diskProⱼ are provided as metrics data of the j^{th} node. In some examples, 0≤cpuProⱼ<1, 0≤memProⱼ<1, 0≤netProⱼ<1, and 0≤diskProⱼ<1.

In accordance with implementations of the present disclosure, a similarity score(s) is determined for each service-node pair for the service group. In some examples, the similarity score is determined as a Dice similarity, which can be described as a score that represents the similarity between two elements, the service and the node in the service-node pair. In the context of the present disclosure, the elements include an i^{th} service and a j^{th} node. The following example relationship can be provided:

$${s}_{i , j} = \frac{2 \times {rs}_{i} \times r {min}_{i , j}^{T}}{{‖ {rs}_{i} ‖}^{2} + {‖ r {min}_{i , j} ‖}^{2}}$$

where T means transposition of vector, rmin_{i,j} is the minimum value between rsᵢ and rnⱼ, and can be determined using the following example relationship:

$$\begin{matrix}r {min}_{i , j} = min ( {rs}_{i} , {rn}_{j} ) \\ = [ cpu {Min}_{i , j} , mem {Min}_{i , j} , net {Min}_{i , j} , disk {Min}_{i , j} ] \\ = [ min ( {cpuReq}_{i} , {cpuPro}_{j} ) , min ( {memReq}_{i} , {memPro}_{j} ) , \\ min ( {netReq}_{i} , {netPro}_{j} ) , min ( {diskReq}_{i} , {diskPro}_{j} ) ]\end{matrix}$$

In some examples, vector operations are provided as:

$${rs}_{i} \times r {min}_{i , j}^{T} = {cpuReq}_{i} \cdot cpu {Min}_{i , j} + {memReq}_{i} \cdot mem {Min}_{i , j} + {netReq}_{i} \cdot net {Min}_{i , j} + {diskReq}_{i} \cdot disk {Min}_{i , j} \\ {‖ {rs}_{i} ‖}^{2} = {cpuReq}_{i}^{2} + {memReq}_{i}^{2} + {netReq}_{i}^{2} + {diskReq}_{i}^{2} \\ {‖ r {min}_{i , j} ‖}^{2} = cpu {Min}_{i , j}^{2} + mem {Min}_{i , j}^{2} + net {Min}_{i , j}^{2} + disk {Min}_{i , j}^{2}$$

After determining all of the similarity scores, a similarity matrix between the P services within a service group and the N nodes, where N=P, can be provided as:

$$S = [ \begin{matrix}{s}_{1 , 1} & {s}_{1 , 2} & … & {s}_{1 , n} \\ {s}_{2 , 1} & {s}_{2 , 2} & … & {s}_{2 , n} \\ … & … & … & … \\ {s}_{n , 1} & {s}_{n , 2} & … & {s}_{n , n}\end{matrix} ]$$

In some implementations, a bipartite graph is constructed for the services of each service group and the nodes. In some examples, one side of the bipartite graph includes the N services and the other side of the bipartite graph includes the N nodes. Edges connect each service and each node, each edge have an edge weight associated therewith. An edge weight can represent a similarity between a service and a node in a service-node pair relative to similarities of all other service-node pairs in the bipartite graph. In some examples, the edge weight for the edge between the i^{th} service and a j^{th} node can be calculated as:

$${e}_{i , j} = round ( \frac{100 \cdot {s}_{i , j}}{{s}_{max}} )$$

where s_{i,j} is the similarity between the i^{th} service and a j^{th} node, and sₘₐₓ is the max value of the similarity matrix. The function round means rounding the double value to an integer. In some examples, 0≤e_{i,j}≤100. After determining all of the edge weights, an adjacency matrix between the N services and the N nodes can be provided as:

$$E = [ \begin{matrix}{e}_{1 , 1} & {e}_{1 , 2} & … & {e}_{1 , n} \\ {e}_{2 , 1} & {e}_{2 , 2} & … & {e}_{2 , n} \\ … & … & … & … \\ {e}_{n , 1} & {e}_{n , 2} & … & {e}_{n , n}\end{matrix} ]$$

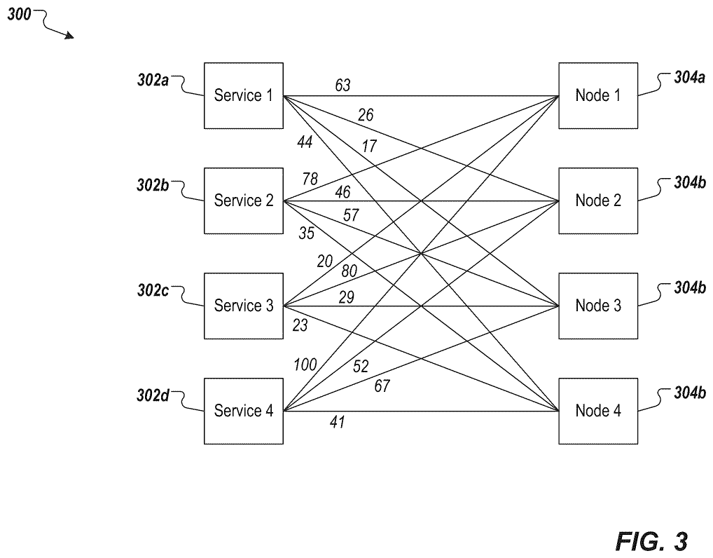

FIG. 3 depicts a representation of a bipartite graph 300 in accordance with implementations of the present disclosure. In the example of FIG. 3, the bipartite graph 300 includes a set of services 302a, 302b, 302c, 302d of a service group and a set of nodes 304a, 304b, 304c, 304d. The example of FIG. 3 represents one service group of K service groups, which includes P services (out of M services that are to be deployed) and N nodes, where N=4.

In the example of FIG. 3, a similarity matrix can be determined to be:

$$S = [ \begin{matrix}0.52 & 0.21 & 0.14 & 0.36 \\ 0.62 & 0.38 & 0.47 & 0.29 \\ 0.16 & 0.71 & 0.24 & 0.19 \\ 0.82 & 0.43 & 0.55 & 0.34\end{matrix} ]$$

As such, an adjacency matrix of the bipartite graph 300 can be provided as:

$$E = [ \begin{matrix}63 & 26 & 17 & 44 \\ 78 & 46 & 57 & 35 \\ 20 & 87 & 29 & 23 \\ 100 & 52 & 67 & 41\end{matrix} ]$$

It can be noted that the bipartite graph 300 is depicted as a visual representation. However, the bipartite graph can be recorded in a computer-readable data structure, such as a table, that records service and node pairs for each service group and edge weights for each service and node pair.

After the bipartite graph is provided, maximum matching edges for the bipartite graph are determined. In some examples, the Hungarian algorithm can be used and can be described as a combinatorial optimization algorithm that solves an assignment problem (combinatorial optimization) in polynomial time (O(n^{k}) for some positive constant k). It ensures that the total length of the selected edges in the bipartite graph are the maximum values. Every selected edge represents a service and a node pair. As such, the N services match the N nodes with the maximum value of the sum of similarity.

To illustrate this, the example bipartite graph 300 of FIG. 3 can be considered. In the example of FIG. 3, the maximum matching is determined to be the service-node pairs: (service1, node4), (service2, node3), (service3, node2), (service4, node1). The total weight of the selected edges is 281 (i.e., 44+57+80+100=281) and the sum of similarity is 2.36 (e.g., 0.36+0.47+0.71+0.82=2.36).

After determining the maximum matching edges and, thus, service-node pairs for the service group, the services of the service group are deployed for execution to the nodes. That is, each service is deployed to the node that it is paired with. With non-limiting reference to the example of FIG. 3, service1 is deployed in node4, service2 is deployed in node3, service3 is deployed in node2, and service4 is deployed in node1. In some examples, deployment of a service includes instantiating an instance of the service within the node for execution.

After deployment, load tests are executed on the deployed services to simulate the real-world loads and the available resources that can be provided by the nodes are updated. In some examples, a load test is designed to emulate real-world loads that would be put on the resources. For example, a load test can include a set of calls and payloads to a service, to initiate processing of the payloads by the service, thus applying a load to the resources. In some examples, the available resources under load are provided as metrics data from the container orchestration system.

The above-discussed process is repeated for each of the other service groups one by one, until all of the services have been deployed to nodes. In some examples, for a service group having R services where N>R, one or more placeholder services can be used. In such instances, the similarity score between a placeholder service and each node is set equal to 0. After finding the maximum matching for the bipartite graph, the placeholder services are removed, and the (actual) services are deployed. To illustrate this, the non-limiting example above can be considered, in which there are 7 service groups with 6 of the service groups each having 4 services assigned thereto, and 1 of the service groups having 3 services assigned thereto. When processing the service group having 3 services assigned thereto, 1 mock service can be added with a similarity score of 0 for each node.

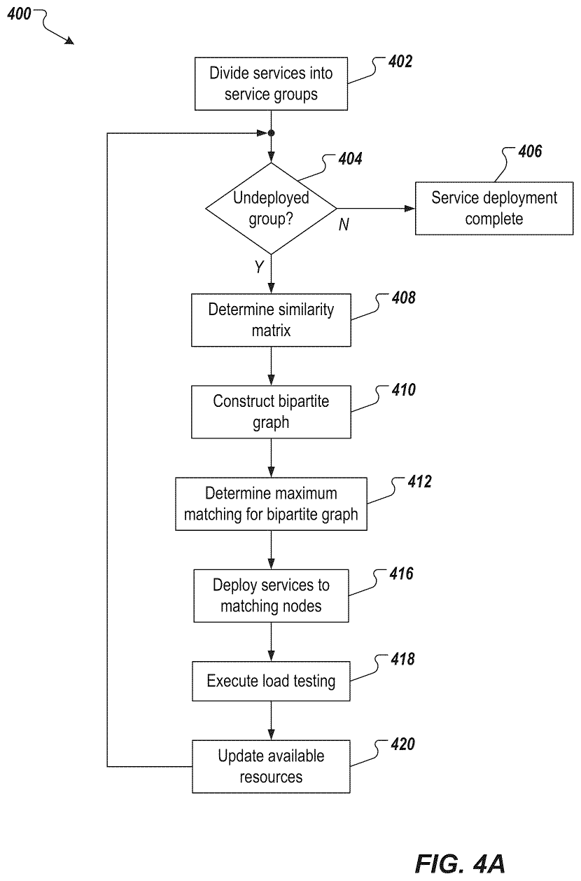

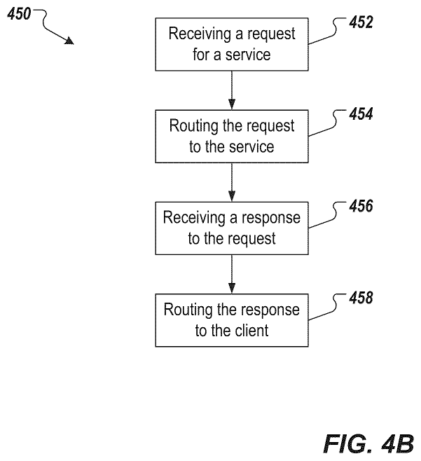

FIG. 4A depicts an example process 400 that can be executed in accordance with implementations of the present disclosure. In some examples, the example process 400 is provided using one or more computer-executable programs executed by one or more computing devices. In some examples, the example process 400 is executed to deploy services to nodes in a cloud infrastructure. Historical execution of services provide data representative of resource consumption of each service, which is used to determine which nodes to deploy respective services, as described in detail herein. In this sense, the example process 400 can be executed to deploy additional instances of services in the cloud infrastructure and/or to redeploy previously deployed services in the cloud infrastructure.

A set of services is divided into service groups (402). For example, a set of M services that are to be deployed for execution on N nodes of a container orchestration system can be identified (e.g., as a table of to-be-deployed services). As described herein, the set of M services can be divided into K service groups, where most, if not all of the service groups contain P services where N=P (e.g., one service group could contain R services where N>R services). In some examples, the set of M services that are to be deployed is provided in a computer-readable file that can be processed by a control plane (e.g., the control plane 202 of FIG. 2).

It is determined whether any of the service groups is undeployed (404). For example, it can be determined whether all service groups, and by extension, all services in the set of M services have been deployed to the N nodes for execution. In some examples, the control plane 202 can monitor group-based deployment of services to determine whether any of the service groups is undeployed. If the services of all service group have been deployed, it can be determined that service deployment is complete (406).

If the services of all service group have been deployed, a similarity matrix is determined for a service group (408). For example, and as described herein, the similarity matrix is determined by calculating a similarity score(s) (e.g., Tanimoto similarity) for each service-node pair in the service group, and populating the similarity matrix with the similarity scores. A bipartite graph is constructed (410). For example, and as described herein, the bipartite graph is provided as a graph of services in the service group and nodes, where each service is connected to each of the nodes by an edge (see, e.g., FIG. 3). As also described in detail herein, an adjacency matrix is provided for the bipartite graph and includes edge weights, each edge weight being associated with an edge of the bipartite graph.

Maximum matching is determined for the bipartite graph (412). For example, and as described herein, the Hungarian algorithm can be used to determine maximum matching of edges and ensure that the total length of the selected edges in the bipartite graph are the maximum values. Every selected edge represents a service and a node pair. As such, the N services match the N nodes with the maximum value of the sum of similarity. In the example of FIG. 3, the maximum matching is determined to be the service-node pairs: (service1, node4), (service2, node3), (service3, node2), (service4, node1). Services are deployed to matching nodes (416). For example, and as described herein, for each edge selected in the maximum matching, the service is deployed to the edge-connected node.

Load testing is executed (418) and the available resources for each of the nodes are updated (420). For example, test loads are submitted to each of the deployed services for execution to determine resource loads placed on the nodes. In this manner, the resources that remain available on each node after deployment of services of the service group can be evaluated and used for deployment decisions in any remaining service group.

The example process 400 loops back to determine whether all service groups have been processed. As noted above, for a service group having less than N services, one or more placeholder services can be used. In such instances, the similarity score between a placeholder service and each node is set equal to 0. After finding the maximum matching for the bipartite graph, the placeholder services are removed, and the (actual) services are deployed.

FIG. 4B depicts an example process 450 that can be executed in accordance with implementations of the present disclosure. In some examples, the example process 450 is provided using one or more computer-executable programs executed by one or more computing devices. The example process 450 can be executed to handle requests to services that are deployed to nodes in accordance with implementations of the present disclosure.

A request for a service is received (452). For example, the client 230 of FIG. 2 transmits a request for a service over the network 232 and a component within the cloud infrastructure receives the request. In some examples, the request includes a payload (e.g., data to be processed by the service) and a service identifier that uniquely identifies the service. The request is routed to the service (454). For example, an instance of the service that is to handle the request is determined and the request is routed to the service for execution. In some examples, a node that executes the service identified by the service identifier is determined and the request is transmitted to the node for execution thereon. A response to the request is received (456). For example, the service processes the request and provides a response to the request. The response is routed to the client (458). For example, the component within the cloud infrastructure returns the response to the client that had sent the underlying request.

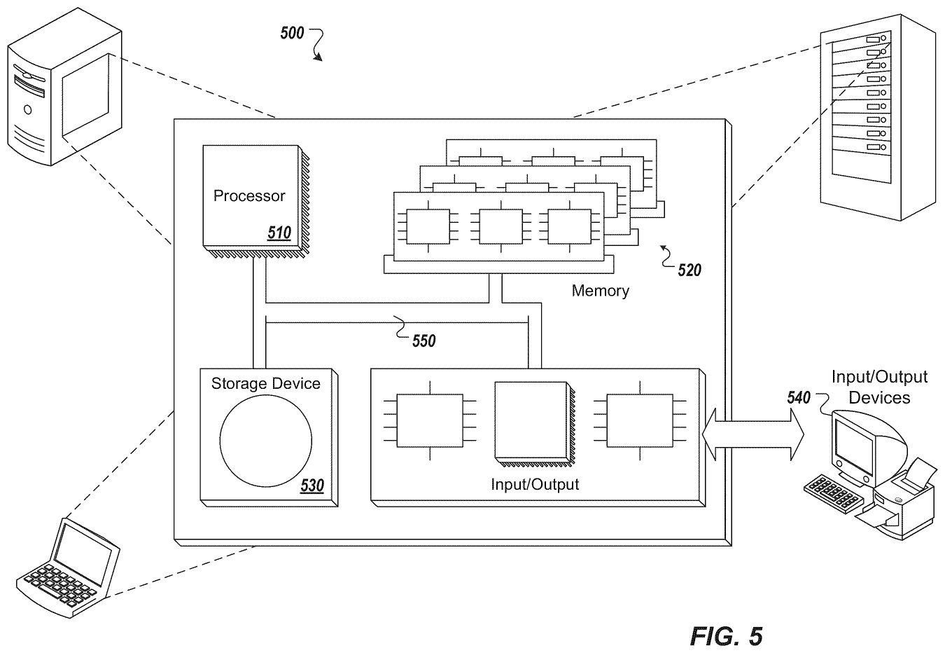

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for deploying services for execution on nodes in cloud computing environments, the method being executed by one or more processors and comprising:
dividing a set of services that are to be deployed to nodes in a set of nodes into a set of service groups, the set of nodes being provisioned in a container orchestration system in a cloud computing environment;
determining, for a first service group in the set of service groups, a similarity matrix comprising a set of similarity scores, each similarity score representative of a similarity between a service in the first service group and a node in the set of nodes in terms of resources required by the service and available resources of the node;
generating, for the first service group in the set of service groups, a first bipartite graph comprising, for each service in the first service group, a set of edges, each edge connecting the service to a node in the set of nodes and having an edge weight;
providing a first set of service-node pairs for the first service group based on edge weights of the first bipartite graph; and
for each service in the first service group, deploying the service to a node in a respective service-node pair for execution in the cloud computing environment.

2. The method of claim 1, wherein the first set of service-node pairs is determined by executing maximum matching over the first bipartite graph based on the edge weights.

3. The method of claim 1, wherein available resources comprise processing, memory, and network bandwidth.

4. The method of claim 1, further comprising:
executing load testing of nodes in the set of nodes, to which the services in the first service group are deployed; and
updating available resources of the nodes in the set of nodes based on the load testing.

5. The method of claim 1, further comprising:
providing a second set of service-node pairs for a second service group based on edge weights of a second bipartite graph; and
for each service in the second service group, deploying the service to a node in a respective service-node pair for execution in the cloud computing environment.

6. The method of claim 5, wherein the second service group comprises at least one placeholder service.

7. The method of claim 1, wherein the edge weights of the second bipartite graph are determined at least partially based on updated available resources of the nodes in the set of nodes after deployment of nodes in the first service group to the nodes in the set of nodes.

8. The method of claim 1, further comprising:
receiving a request for the service; and
transmitting the request to the node for execution by the service.

9. The method of claim 1, wherein a number of services in the set of services is evenly divisible by a number of nodes in the set of nodes, such that each service group in the set of service groups has the same number of services therein.

10. The method of claim 1, wherein a number of services in the set of services is not evenly divisible by a number of nodes in the set of nodes, such that one service group in the set of service groups has fewer services therein than other service groups in the set of service groups.

11. The method of claim 1, further comprising providing an adjacency matrix comprising a matrix of edge weights, each edge weight corresponding to a service-node pair and representing a similarity between a service and a node in the service-node pair relative to similarities of all other service-node pairs in the bipartite graph.

12. A non-transitory computer-readable storage medium coupled to one or more processors and having instructions stored thereon which, when executed by the one or more processors, cause the one or more processors to perform operations for deploying services for execution on nodes in cloud computing environments, the operations comprising:
dividing a set of services that are to be deployed to nodes in a set of nodes into a set of service groups, the set of nodes being provisioned in a container orchestration system in a cloud computing environment;
determining, for a first service group in the set of service groups, a similarity matrix comprising a set of similarity scores, each similarity score representative of a similarity between a service in the first service group and a node in the set of nodes in terms of resources required by the service and available resources of the node;
generating, for the first service group in the set of service groups, a first bipartite graph comprising, for each service in the first service group, a set of edges, each edge connecting the service to a node in the set of nodes and having an edge weight;
providing a first set of service-node pairs for the first service group based on edge weights of the first bipartite graph; and
for each service in the first service group, deploying the service to a node in a respective service-node pair for execution in the cloud computing environment.

13. The non-transitory computer-readable storage of claim 12, wherein the first set of service-node pairs is determined by executing maximum matching over the first bipartite graph based on the edge weights.

14. The non-transitory computer-readable storage of claim 12, wherein available resources comprise processing, memory, and network bandwidth.

15. The non-transitory computer-readable storage of claim 12, wherein operations further comprise:
executing load testing of nodes in the set of nodes, to which the services in the first service group are deployed; and
updating available resources of the nodes in the set of nodes based on the load testing.

16. The non-transitory computer-readable storage of claim 12, wherein operations further comprise:
providing a second set of service-node pairs for a second service group based on edge weights of a second bipartite graph; and
for each service in the second service group, deploying the service to a node in a respective service-node pair for execution in the cloud computing environment.

17. A system, comprising:
a computing device; and
a computer-readable storage device coupled to the computing device and having instructions stored thereon which, when executed by the computing device, cause the computing device to perform operations for deploying services for execution on nodes in cloud computing environments, the operations comprising:
dividing a set of services that are to be deployed to nodes in a set of nodes into a set of service groups, the set of nodes being provisioned in a container orchestration system in a cloud computing environment;
determining, for a first service group in the set of service groups, a similarity matrix comprising a set of similarity scores, each similarity score representative of a similarity between a service in the first service group and a node in the set of nodes in terms of resources required by the service and available resources of the node;
generating, for the first service group in the set of service groups, a first bipartite graph comprising, for each service in the first service group, a set of edges, each edge connecting the service to a node in the set of nodes and having an edge weight;
providing a first set of service-node pairs for the first service group based on edge weights of the first bipartite graph; and
for each service in the first service group, deploying the service to a node in a respective service-node pair for execution in the cloud computing environment.

18. The system of claim 17, wherein the first set of service-node pairs is determined by executing maximum matching over the first bipartite graph based on the edge weights.

19. The system of claim 17, wherein available resources comprise processing, memory, and network bandwidth.

20. The system of claim 17, wherein operations further comprise:
executing load testing of nodes in the set of nodes, to which the services in the first service group are deployed; and
updating available resources of the nodes in the set of nodes based on the load testing.
